(19) United States
(12) Patent Application Publication
(10) Pub. No.: US 2005/0053418 A1
(43) Pub. Date: Mar. 10, 2005

(54) Pattern/project organizer

(76) Inventor: Catherine Solich, Cape Coral, FL (US)

Correspondence Address: Catherine Solich, 829 SW 15th Ave., Cape Coral, FL, 33991, US

(21) Appl. No.: 10/659,405

(22) Filed: Sep. 10, 2003

(51) Int. Cl. B42F 13/00

(52) U.S. Cl. 402/79

(57) ABSTRACT

An organizer for patterns or projects includes at least two plastic, flexible and see-through sheets that are superimposed over each other to form a compartment. The compartment is subdivided into several other compartments to store selected articles therein. Some of the compartments have plain entry openings therein, while other compartments have a releasable open and closed opening therein.

### CROSS REFERENCE TO RELATED APPLICATIONS

(none)

### STATEMENT REGARDING FED SPONSORED R & D

(none)

### BACKGROUND OF THE INVENTION

The invention is directed to an organizer involving the various paraphernalia that are used when doing needle work such as embroidery, cross stitching, petty point etc. including the pattern which is used the follow the path and sequence of the stitches one has to follow to accomplish the task at hand. Many tasks involve the use of many different items or tools that are used in a handicraft. Such items are different sized needles, a needle threader, a thimble, differently sized patterns, Velcro™ patches, and many differently colored yarn holders and many more. These items are normally contained in an embroidery box that may have several compartments of different sizes and shapes. In any of theses embroidery boxes it is almost impossible to separate the variously sized items from each, especially, to keep the various thread items from each without tangling which greatly hinders the progress of the work at hand.

### SUMMARY AND OBJECTS OF THE INVENTION

It is an object of the invention to separate the above noted handicraft items from each other but to store the same in an easily identifiable manner. All of the items are located and stored next to each other, can easily be seen but do not have contact with other. The way to store these items are plastic see-through sheets having differently sized compartments therein. The see-through sheets can easily be stored in two- or three-binders or in binders having clamps therein.

As is well known, these binders can store many sheets adjacent to each other and the various sheets can quickly be identified just by leafing through the same. In this manner, many different handicraft jobs can be stored side by side and can easily identified and will not be intermingled with each other or intermingled within any one project.

### BRIEF DESCRIPTION OF THE DRAWINGS

FIG. 1 illustrates a storage sheet made of a see-through material having four compartments therein;

FIG. 2 shows the arrangement of FIG. 1 having two compartments therein;

FIG. 3 shows the arrangement of FIG. 2 wherein the two compartments have different openings.

### DETAILED DESCRIPTION OF THE INVENTION

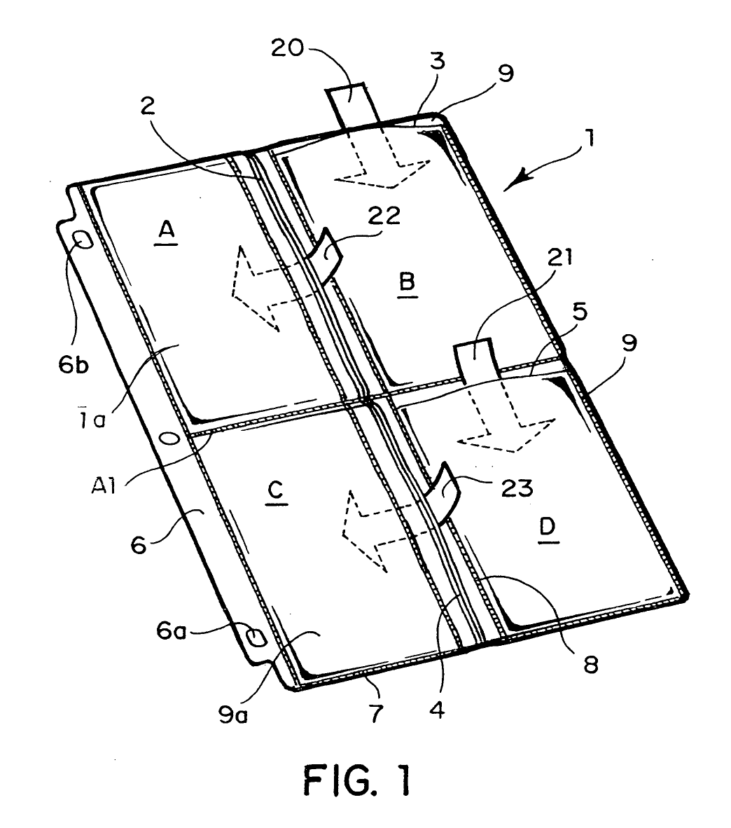

FIG. 1 illustrates the basic concept of the invention. The basic organizer consists of a sheet 1 made up of two plastic sheets of clearview and supple or flexible material. One of the sheets, a backing sheet 9, has a second sheet 9a attached thereto such as by heat welding or any other way. The backing sheet 9 remains undisturbed but the cover sheet can be divided to form four different compartments. In FIG. 1 there are shown four different compartments A, B, C, D. Each of the compartments can be treated or structured differently to form different subdivided compartments for different purposes. Compartment A, for example, is heat sealed to the backing sheet 9 at A1 but is not attached to the backing sheet 9 at the right side of the quadrant a. This side is left open and is accessible as shown by the arrow 22. This side should be resealable by the resealable closure 2. Any items to be stored or displayed would be inserted through the resealable closure 2. Turning now to the compartment B in FIG. 1, there is shown a different way of entering the compartment B which has an always opening 3 as is indicated by the arrow 20. The third compartment C is open to the right of or in the of the sheet 1 as is indicated by the arrow 23. This opening may be resealable as is indicated by the reference character 4. The fourth quadrant D is similar to the arrangement of quadrant B in that there is top opening which is accessible as is indicated by the arrow 21. The left side of the Quadrant D is heat sealed against the backing sheet 9 at 8. Of course the front or top sheet 1a and 9a and the back sheet 9 are heat sealed to each other around the outer periphery to form a broad compartment which may be subdivided in many different ways to form differently sized compartments. The organizer, as explained above may be assembled with like or other organizers in a collective binder. In this regard FIG. 1 shows a tab 6 at the edge of the organizer sheet 1. This edge may have two or three holes therein for placing the same over the rings of a two three ring binder. Such holes for that purpose are shown at 6a and 6b. Other binders have a clamp at the spine of the binder. Therefore, the organizer sheets can be installed or assembled in such a binder. The end result is that the pattern or projects can be assembled in an easily referenced collection.

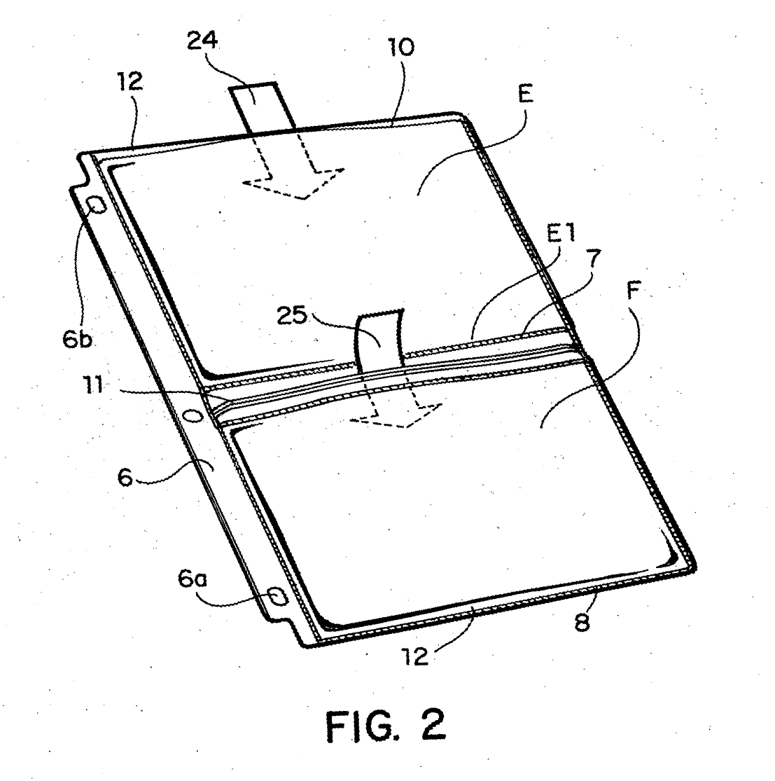

FIG. 2 includes the same basic principle of displaying and storing handy-craft items in a somewhat different manner. In this Fig., the same basic back 9 and front sheet 9a are used, however, the compartment are divided in a different manner. In FIG. 2, the organizer is subdivided into just two compartments E and F. The first compartment E has a permanently open upper end 10 as is shown by the arrow 24. The top compartment ends at E1 by heat sealing procedures. The lower compartment has an opening as shown by the arrow 25 but this opening may be resealable by a pressure type fastener.

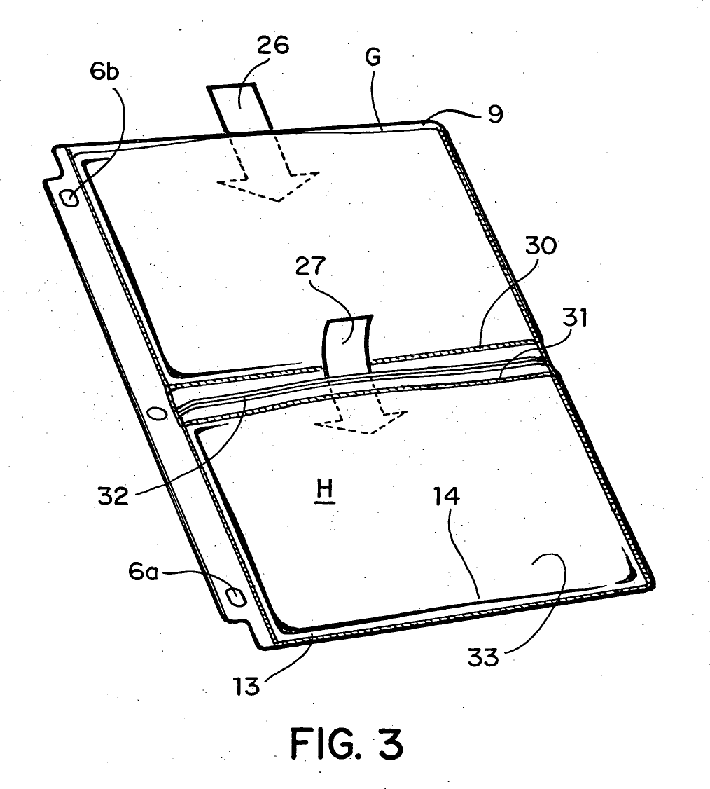

FIG. 3 again shows two compartments G and H as were shown in FIG. 2. However, in this arrangement the Compartment G extends the full length of the backing sheet 13 by having the front sheet 9 superimposed to thereby form a large compartment.

However the front sheet can be subdivided by providing a second opening midway down the front sheet as is indicated by the arrow 27. A resealable closure 32 is attached to the front sheet by the heat seams 30 and 31. This compartment H also ends at the bottom where compartment G ends. This way the large compartment G can be entered through the arrow 26 and through arrow 27 into a smaller compartment.

From all of the above, it can be seen that a versatile pattern and project organizer has been created. The organizer, of course has many other uses such as for stamp and coin collectors to use as a temporary storage and visually detecting and organizing unit.

1. A pattern and project organizer comprising at least two flexible sheets of see-through plastic material having edges and being superimposed over each other and sealed together at their edges, at least two compartments being created between said at least two superimposed sheets, a first compartment being open at a top edge of said at least two sheets and being closed by a bottom seal substantially at a middle of said two sheets, a second of said two compartments being located at a bottom of said at least two sheets and having an opening substantially at the middle of said two superimposed sheets and below said bottom seal, means for releasably sealing said opening.

2. The organizer of claim 1 including means for fastening said organizer in a binder.

3. The organizer of claim 1, wherein said first compartment extends to a bottom of said two superimposed sheets to thereby form a large compartment, wherein said bottom is constructed as an expandable fold.

4. The organizer of claim 1, wherein said at least two compartments are four compartments divided into two compartments on a left side of said at least two superimposed sheet and two compartments on a right side of said at least two superimposed sheets, said two compartments on the left side each having means for releasably sealing an entry into said compartments, said two compartments on said right side are open all the time for entry of articles therein.

5. A pattern and project organizer being constructed of two superimposed flexible, see-through plastic material sheets forming a compartment there between and several individual compartments are subdivided within said two superimposed sheets, said compartments are separated from and are independent of each other, some of said compartments have open entry ends, others of said compartments having means for releasably sealing an entry into said compartments.

6. The organizer of claim 5 including means for fastening said organizer into an organizer holder.

7. The organizer of claim 6, wherein said organizer holder is a two ring binder.

8. The organizer of claim 6, wherein said organizer holder is a three ring binder.

9. (canceled)

10. The organizer of claim 1 wherein said bottom seal is constructed as an expandable fold.
